(19) United States
(12) Patent Application Publication
(10) Pub. No.: US 2006/0101139 A1
(43) Pub. Date: May 11, 2006

(54) Real-time alerts within a web browser

(75) Inventors: Harry Hornreich, Rehovot (IL); Shiri Lupovici, Modi'in (IL); Marty Moore, Somerville, MA (US); Marjorie Scheiter, Rehovot (IL); Haim Schneider, Ramot Meir (IL)

Correspondence Address: HOFFMAN, WARNICK & D'ALESSANDRO LLC, 75 STATE ST, 14TH, ALBANY, NY, 12207, US

(73) Assignee: International Business Machines Corporation, Armonk, NY (US)

(21) Appl. No.: 10/983,818

(22) Filed: Nov. 8, 2004

(51) Int. Cl. G06F 15/173

(52) U.S. Cl. 709/224

(57) ABSTRACT

A real-time browser window alert system including a real-time alert sub-system including a session manager operative to monitor a session in which a web page is active within a window of a browser on a client computer, and an alert buffer operative to store an alert destined for the client computer, a monitor operative to poll the sub-system for the existence of alerts destined for the client computer and retrieve the alert to the client computer, and an alert controller operative to modify an alert area within the window for providing the alert therein.

### BACKGROUND OF THE INVENTION

1. Technical Field

The present invention relates to client-server technology in general, and in particular to providing alerts within a web browser window.

2. Background Art

In today's increasingly fast-paced workplace, it is increasingly important to provide managers and employees with work-related information as soon as it becomes available. For example, the sooner a marketing professional is notified that a new request for information (RFI) has been submitted in one of the accounts for which he/she is responsible, the better. Ideally, it would be best to integrate a real-time alert capability into the work environment itself. The widespread use of Intranets and portals has resulted in many workers working mostly, and sometimes exclusively, with a web page browser. For such workers it would be advantageous to receive real-time alerts within their active web browser window.

### SUMMARY OF THE INVENTION

The present invention provides real-time alerts within an active web browser window.

In one aspect of the present invention, a real-time browser window alert system is provided including a real-time alert sub-system including a session manager operative to monitor a session in which a web page is active within a window of a browser on a client computer, and an alert buffer operative to store an alert destined for the client computer, a monitor operative to poll the sub-system for the existence of alerts destined for the client computer and retrieve the alert to the client computer, and an alert controller operative to modify an alert area within the window for providing the alert therein.

In another aspect of the present invention, the system further includes a server computer operative to host the web page for downloading to the client computer via a computer network.

In another aspect of the present invention, the session is associated with the client computer via an identifier received from the client computer.

In another aspect of the present invention, the identifier identifies a user currently using the client computer.

In another aspect of the present invention, the identifier is matchable to the alert bearing the same identifier.

In another aspect of the present invention, the alert is received from a publish/subscribe server in response to a publication received from a content provider in connection with a subscription associated with a user currently using the client computer.

In another aspect of the present invention, the monitor is received at the client computer in association with the web page.

In another aspect of the present invention, the monitor is received at the client computer together with the web page.

In another aspect of the present invention, the monitor is implemented using an XMLHttpRequest object.

In another aspect of the present invention, the monitor is implemented using a hidden iFrame.

In another aspect of the present invention, the monitor maintains a persistent connection with the sub-system through which the monitor receives the alerts as they arrive at the sub-system.

In another aspect of the present invention, the alert controller is operative to present the alert in at least one of a visual manner and an audible manner.

In another aspect of the present invention, the alert controller is operative to present the alert in a popup browser window on the client computer separate from the window in which the web page is active.

In another aspect of the present invention, the alert controller is operative to request that a user perform an action responsive to the alert.

In another aspect of the present invention, the alert controller is operative to provide the responsive action for transmission to the sub-system.

In another aspect of the present invention, the sub-system is operative to provide the responsive action to the source of the alert.

In another aspect of the present invention, a method is provided for providing real-time alerts, the method including monitoring a session in which a web page is active within a window of a browser on a client computer, storing an alert in association with the session, providing the alert to the client computer, and modifying an alert area within the window for providing the alert therein.

In another aspect of the present invention, the method further includes polling for the existence of alerts destined for the client computer.

In another aspect of the present invention, the polling step includes polling using an XMLHttpRequest object.

In another aspect of the present invention, the polling step includes polling using a hidden iFrame.

In another aspect of the present invention, the method further includes creating the session in association with an identifier received from the client computer.

In another aspect of the present invention, the storing step includes matching an alert identifier to the identifier associated with the session.

In another aspect of the present invention, the creating step includes creating where the identifier identifies a user currently using the client computer.

In another aspect of the present invention, the method further includes receiving the alert from a publish/subscribe server in response to a publication received from a content provider in connection with a subscription associated with a user currently using the client computer.

In another aspect of the present invention, the method further includes maintaining a persistent connection for receiving the alerts as they arrive.

In another aspect of the present invention, the modifying step includes presenting the alert in at least one of a visual manner and an audible manner.

In another aspect of the present invention, the modifying step includes presenting the alert in a popup browser window on the client computer separate from the window in which the web page is active.

In another aspect of the present invention, the method further includes requesting that a user perform an action responsive to the alert.

In another aspect of the present invention, the method further includes providing the responsive action for transmission to the source of the alert.

In another aspect of the present invention, a method is provided for implementing a real-time browser window alert system, the method including providing a real-time alert sub-system including a session manager operative to monitor a session in which a web page is active within a window of a browser on a client computer, and an alert buffer operative to store an alert destined for the client computer, providing a monitor operative to poll the sub-system for the existence of alerts destined for the client computer and retrieve the alert to the client computer, and providing an alert controller operative to modify an alert area within the window for providing the alert therein.

In another aspect of the present invention, a computer program is provided embodied on a computer-readable medium, the computer program including a first code segment operative to monitor a session in which a web page is active within a window of a browser on a client computer, a second code segment operative to store an alert destined for the client computer, a third segment operative to poll for the existence of alerts destined for the client computer and retrieve the alert to the client computer, and a fourth code segment operative to modify an alert area within the window for providing the alert therein.

### BRIEF DESCRIPTION OF THE DRAWINGS

The present invention will be understood and appreciated more fully from the following detailed description taken in conjunction with the appended drawings in which:

FIG. 1 is a simplified block-flow diagram of a real-time browser window alert system, constructed and operative in accordance with a preferred embodiment of the present invention; and

FIG. 2 is a simplified flowchart illustration of an exemplary method of operation of the real-time browser window alert system of FIG. 1.

### DETAILED DESCRIPTION OF THE INVENTION

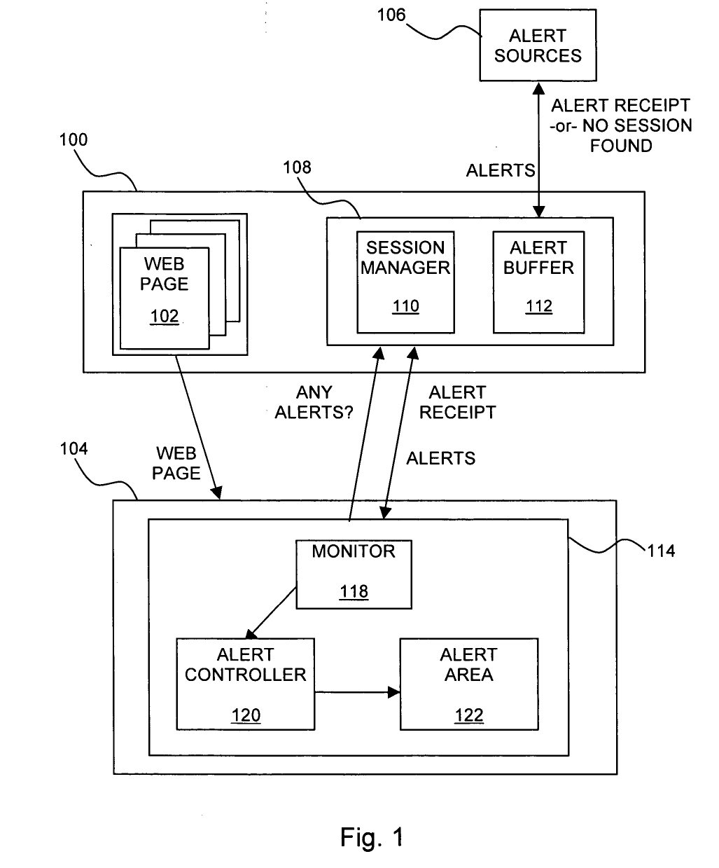

Reference is now made to FIG. 1, which is a simplified block-flow diagram of a real-time browser window alert system, constructed and operative in accordance with a preferred embodiment of the present invention. In the system of FIG. 1, a server computer 100 hosts one or more web pages 102, such as may be downloaded to a client computer 104 via a computer network, such as the Internet. Server 100 also preferably includes a real-time alert sub-system 108 which preferably includes a session manager 110 and an alert buffer 112. Session manager 110 monitors one or more sessions in which a web page 102 is currently displayed or is otherwise active within a window of a browser 114 on client computer 104. Each session is preferably associated with client computer 104 and/or a user currently at client computer 104 by way of an identifier that is received from client computer 104, such as an identifier of client computer 104 or the user, and that may be matched to alerts bearing the same identifier. Alert buffer 112 stores alerts destined for display at client computer 104 that are received from any source 106, such as from publish/subscribe servers in response to publications received from content providers in connection with subscriptions associated with a user currently at client computer 104.

Web page 102 preferably includes a monitor 118 that, once active within browser 114, periodically polls sub-system 108 for the existence of alerts destined for display at client computer 104. Monitor 118 may be implemented using JavaScript™, a hidden Java™ applet, or any other technology supported by browser 114 that allows background polling of sub-system 108 for the existence of alerts and for receipt of the alert. For example, where JavaScript™ is used, an XMLHttpRequest object or a hidden iFrame may be used into which alerts may be received in the background using HTTP. Alternatively, monitor 118 maintains a persistent connection with sub-system 108 through which monitor 118 receives alerts as they arrive at server 100. Once an alert is received, monitor 118 preferably calls an alert controller 120 within web page 102 that modifies an alert area 122 within its window of browser 114 to provide the incoming alert to the user, such as may be implemented using JavaScript™ and Dynamic HTML (DHTML). The alert may be presented visually and/or audibly, such as by combining a flashing message and a sound effect. Additionally or alternatively, the alert may be displayed in a separate popup browser window. Alert controller 120 may request that the user perform an action to indicate that he has received the alert, such as by asking the user to click on an ‘OK’ button. Alert controller 120 may then indicate the user's response to monitor 118, which may send messages back to sub-system 108, such as to indicate that an alert was received or read, whereupon sub-system 108 may send the alert receipt indication back to the alert source 106 that provided the alert.

The alert data may consist of an alert body and other optional fields such as the alert subject, alert source, alert time, etc. The alert may be represented in any known format, such as an XML document. If an XMLHttpRequest object is used to load the alert data, the data is received as an XML document. If a hidden iFrame is used, the XML document may be provided as a JavaScript™ constant inside a web page that is loaded into the iFrame.

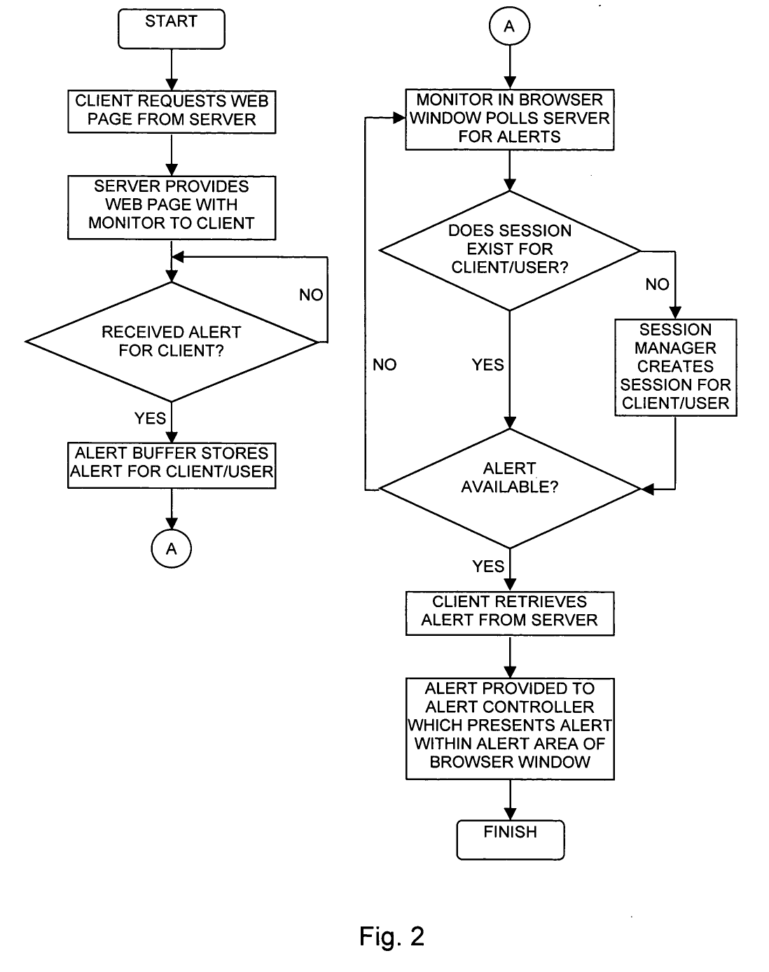

Reference is now made to FIG. 2, which is a simplified flowchart illustration of an exemplary method of operation of the real-time alert system of FIG. 1, operative in accordance with a preferred embodiment of the present invention. In the method of FIG. 2, when a request for web page 102 is received from client computer 104, server 100 provides web page 102 together with monitor 118 to client computer 104, which is displayed within a window or otherwise made active within browser 114. Client computer 104 provides one or more identifiers to sub-system 108, such as an identifier identifying a user currently at client computer 104. For each client computer and/or user identifier received by session manager 110 from client computer 104, a separate identifier/client session is preferably created, typically when monitor 118 first requests alerts from sub-system 108. Session manager 110 may receive identifiers for creating sessions as part of client computer 104's request for web page 102 or as part of a communication from monitor 118. User identifiers may be gleaned from web pages retrieved by client computer 104 that include user identification information, such as in a JavaScript™ constant inside the page, or from a cookie stored on client computer 104. Such identification information is typically found at clients for use in intranet or portal applications, which typically requires that the user be authenticated before accessing the application web page. Preferably, the session remains active as long as session manager 110 determines that the web page is currently displayed or is otherwise active at client computer 104.

When an alert is received at sub-system 108, it is preferably buffered by alert buffer 112. Sub-system 108 may attempt to match the alert identifier, indicating for whom the alert is meant, to an identifier of an active session. If no corresponding active session is found, sub-system 108 may optionally notify the alert source 106 from which the alert was received that no active session was found, and that delivery of the alert will be deferred, whereupon alert source 106 may use an alternative method for delivering the alert, such as via SMS.

Monitor 118 preferably periodically polls sub-system 108 for the existence of alerts associated with one or more identifiers that monitor 118 indicates. Sub-system 108 searches alert buffer 112 for alerts with matching identifiers and retrieves any matching alerts from alert buffer 112. Alternatively, monitor 118 maintains a persistent connection with sub-system 108 through which monitor 118 receives matching alerts as they are received by server 100. Monitor 118 provides received alerts to alert controller 120 which presents the alert within alert area 122 within the context of browser 114, such as within the browser window in which web page 102 is currently displayed, or within a separate popup browser window spawned by browser 114.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques. Thus, for example, client-side components described hereinabove may be implemented using the Extensible Markup Language (XML), Hypertext Markup Language (HTML), JavaScript™, Java Applets, ActiveX™, or any combination thereof.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A real-time browser window alert system comprising:
a real-time alert sub-system comprising:
a session manager operative to monitor a session in which a web page is active within a window of a browser on a client computer; and
an alert buffer operative to store an alert destined for the client computer;
a monitor operative to poll the sub-system for the existence of alerts destined for the client computer and retrieve the alert to the client computer; and
an alert controller operative to modify an alert area within the window for providing the alert therein.

2. The system of claim 1, further comprising a server computer operative to host the web page for downloading to the client computer via a computer network.

3. The system of claim 1, wherein the session is associated with the client computer via an identifier received from the client computer.

4. The system of claim 3, wherein the identifier identifies a user currently using the client computer.

5. The system of claim 3, wherein the identifier is matchable to the alert bearing the same identifier.

6. The system of claim 1, wherein the alert is received from a publish/subscribe server in response to a publication received from a content provider in connection with a subscription associated with a user currently using the client computer.

7. The system of claim 1, wherein the monitor is received at the client computer in association with the web page.

8. The system of claim 1, wherein the monitor is received at the client computer together with the web page.

9. The system of claim 1, wherein the monitor is implemented using an XMLHttpRequest object.

10. The system of claim 1, wherein the monitor is implemented using a hidden iFrame.

11. The system of claim 1, wherein the monitor maintains a persistent connection with the sub-system through which the monitor receives the alerts as they arrive at the sub-system.

12. The system of claim 1, wherein the alert controller is operative to present the alert in at least one of a visual manner and an audible manner.

13. The system of claim 1, wherein the alert controller is operative to present the alert in a popup browser window on the client computer separate from the window in which the web page is active.

14. The system of claim 1, wherein the alert controller is operative to request that a user perform an action responsive to the alert.

15. The system of claim 14, wherein the alert controller is operative to provide the responsive action for transmission to the sub-system.

16. The system of claim 14, wherein the sub-system is operative to provide the responsive action to the source of the alert.

17. A method for providing real-time alerts, the method comprising:
monitoring a session in which a web page is active within a window of a browser on a client computer;
storing an alert in association with the session;
providing the alert to the client computer; and
modifying an alert area within the window for providing the alert therein.

18. The method of claim 17, further comprising polling for the existence of alerts destined for the client computer.

19. The method of claim 18, wherein the polling step comprises polling using an XMLHttpRequest object.

20. The method of claim 18, wherein the polling step comprises polling using a hidden iFrame.

21. The method of claim 17, further comprising creating the session in association with an identifier received from the client computer.

22. The method of claim 21, wherein the storing step comprises matching an alert identifier to the identifier associated with the session.

23. The method of claim 21, wherein the creating step comprises creating where the identifier identifies a user currently using the client computer.

24. The method of claim 17, further comprising receiving the alert from a publish/subscribe server in response to a publication received from a content provider in connection with a subscription associated with a user currently using the client computer.

25. The method of claim 17, further comprising maintaining a persistent connection for receiving the alerts as they arrive.

26. The method of claim 17, wherein the modifying step comprises presenting the alert in at least one of a visual manner and an audible manner.

27. The method of claim 17, wherein the modifying step comprises presenting the alert in a popup browser window on the client computer separate from the window in which the web page is active.

28. The method of claim 17, further comprising requesting that a user perform an action responsive to the alert.

29. The method of claim 28, further comprising providing the responsive action for transmission to the source of the alert.

30. A method for implementing a real-time browser window alert system, the method comprising:
providing a real-time alert sub-system comprising:
a session manager operative to monitor a session in which a web page is active within a window of a browser on a client computer; and
an alert buffer operative to store an alert destined for the client computer;
providing a monitor operative to poll the sub-system for the existence of alerts destined for the client computer and retrieve the alert to the client computer; and
providing an alert controller operative to modify an alert area within the window for providing the alert therein.

31. A computer program embodied on a computer-readable medium, the computer program comprising:
a first code segment operative to monitor a session in which a web page is active within a window of a browser on a client computer;
a second code segment operative to store an alert destined for the client computer;
a third segment operative to poll for the existence of alerts destined for the client computer and retrieve the alert to the client computer; and
a fourth code segment operative to modify an alert area within the window for providing the alert therein.
